(19) United States
(12) Patent Application Publication
(10) Pub. No.: US 2024/0174032 A1
(43) Pub. Date: May 30, 2024

(54) APPARATUS AND METHODS FOR PREDICTING TIRE TEMPERATURE LEVELS

(71) Applicant: HERE GLOBAL B.V., Eindhoven (NL)

(72) Inventors: Jeremy Michael YOUNG, Chicago, IL (US); Leon STENNETH, Chicago, IL (US); Jerome BEAUREPAIRE, Courbevoie (FR)

(73) Assignee: HERE GLOBAL B.V., EINDHOVEN (NL)

(21) Appl. No.: 18/071,258

(22) Filed: Nov. 29, 2022

(51) Int. Cl. B60C 23/04; G01C 21/34

(52) U.S. Cl. CPC B60C 23/0476; B60C 23/0481; G01C 21/3453

(57) ABSTRACT

An apparatus, method and computer program product are provided for predicting tire temperature levels. In one example, the apparatus receives input data indicating a target route for a target vehicle, attributes associated with the target vehicle, and attributes of the target route and causes a machine learning model to generate output data as a function of the input data. The output data indicate prediction of tire temperature levels of the target vehicle during a period in which the target vehicle traverses the target route. The machine learning model is trained to generate the output data as a function of the input data based on training data indicating events in which vehicles traversed routes. Specifically, the training data include tire temperature levels of the vehicles, vehicle data associated with the vehicles, map data associated with the routes, and environmental data associated with the routes.

### TECHNICAL FIELD

The present disclosure generally relates to the field of vehicle data prediction, associated methods and apparatus, and in particular, concerns, for example, an apparatus configured to predict tire temperature levels based on attributes of vehicles and routes designated for the vehicles.

### BACKGROUND

Certain vehicles are equipped tire temperature sensors for notifying drivers regarding tire temperature levels. While such sensors are beneficial for informing current tire temperature levels, the application of the sensors are limited to providing real-time values and cannot provide tire temperature levels at a subsequent period of time. As such, drivers using vehicles equipped with said sensors cannot readily plan trips to avoid routes that may potentially induce critical tire temperature levels and damages to tires of the vehicles. Additionally, legacy vehicles are typically not equipped with tire temperature sensors for directly sensing tire temperature levels. As such, tires of said vehicles are directly exposed to harsh road environments. Therefore, there is a need in the art for a system that provides prediction of tire temperature levels and informing drivers to mitigate instances in which tire temperature levels exceed critical levels.

The listing or discussion of a prior-published document or any background in this specification should not necessarily be taken as an acknowledgement that the document or background is part of the state of the art or is common general knowledge.

### BRIEF SUMMARY

According to a first aspect, an apparatus comprising at least one processor and at least one non-transitory memory including computer program code instructions is described. The computer program code instructions, when executed, cause the apparatus to: receive training data indicating events in which vehicles traversed routes, wherein the training data include tire temperature levels of the vehicles during the events, vehicle data indicating one or more attributes of the vehicles, map data indicating one or more attributes of the routes, and environmental data indicating one or more attributes of environments of the routes during the events; and using the training data, train a machine learning model to generate output data as a function of input data, wherein the input data indicate a target route for a target vehicle, one or more attributes associated with the target vehicle, and one or more attributes of the target route, and wherein the output data indicate prediction of one or more tire temperature levels of the target vehicle during a period in which the target vehicle traverses the target route.

In various embodiments, the input data does not include tire temperature levels of the target vehicle.

In various embodiments, the one or more attributes of the vehicles indicates: (i) speed levels of the vehicles; (ii) acceleration or deceleration levels of the vehicles; (iii) total distance travelled by each of the vehicles; (iv) tire pressure levels of the vehicles; (v) specifications of the vehicles; (vi) specifications of wheels of the vehicles; (vii) specifications of tires of the vehicles; (vii) age of each of the vehicles; (xi) age of each tire of the vehicles; (xii) loads of the vehicles; or (xiii) a combination thereof.

In various embodiments, the one or more attributes of the routes indicates: (i) a road surface type; (ii) a road surface condition; (iii) a functional class; (iv) a curvature; (v) a degree of traffic; or (vi) a combination thereof.

In various embodiments, the one or more attributes of the environments of the routes indicates: (i) air temperature levels; (ii) humidity levels; (iii) pavement temperature levels; (iv) precipitation; (v) solar radiation levels; (vi) wind direction and intensity levels; or (vii) a combination thereof.

In various embodiments, the prediction of the one or more tire temperature levels is provided for each tire of the target vehicle.

In various embodiments, the computer program code instructions, when executed, further cause the apparatus to, responsive to the one or more tire temperature levels exceeding a threshold tire temperature level, for each instance in which the one or more tire temperature levels exceeds the threshold tire temperature level: cause a user interface to output a notification for mitigating increase in temperature levels for one or more tires of the target vehicle, wherein the notification indicates: (i) a recommendation to adjust a departure time of the target route; (ii) a recommendation for a driver of the target vehicle to follow predetermined maneuvers during the period in which the target vehicle traverses the target route; (iii) a recommendation for the target vehicle to slow down or slow to a stop for a predetermined period during the period in which the target vehicle traverses the target route; (iv) an alternative route to a destination of the target route; (v) or a combination thereof.

In various embodiments, the computer program code instructions, when executed, further cause the apparatus to, responsive to the one or more tire temperature levels exceeding a threshold tire temperature level, for each instance in which the one or more tire temperature levels exceeds the threshold tire temperature level: determine a precipitation location within the target route; and generate maneuver instructions for traversing the target route based on the precipitation location of the target route.

According to a second aspect, a non-transitory computer-readable storage medium having computer program code instructions stored therein is described. The computer program code instructions, when executed by at least one processor, cause the at least one processor to: receive input data indicating a target route for a target vehicle, one or more attributes associated with the target vehicle, and one or more attributes of the target route; and cause a machine learning model to generate output data as a function of the input data, wherein the output data indicate prediction of one or more tire temperature levels of the target vehicle during a period in which the target vehicle traverses the target route, wherein the machine learning model is trained to generate the output data as a function of the input data based on training data, and wherein the training data indicate events in which vehicles traversed routes, wherein the training data include tire temperature levels of the vehicles during the events, vehicle data indicating one or more attributes of the vehicles, map data indicating one or more attributes of the routes, and environmental data indicating one or more attributes of environments of the routes during the events.

According to a third aspect, a method of providing predicted tire temperature levels is described. The method includes: receiving input data indicating a target route for a target vehicle, one or more attributes associated with the target vehicle, and one or more attributes of the target route; and causing a machine learning model to generate output data as a function of the input data, wherein the output data indicate prediction of one or more tire temperature levels of the target vehicle during a period in which the target vehicle traverses the target route, wherein the machine learning model is trained to generate the output data as a function of the input data based on training data, and wherein the training data indicate events in which vehicles traversed routes, wherein the training data include tire temperature levels of the vehicles during the events, vehicle data indicating one or more attributes of the vehicles, map data indicating one or more attributes of the routes, and environmental data indicating one or more attributes of environments of the routes during the events.

Also, a computer program product may be provided. For example, a computer program product comprising instructions which, when the program is executed by a computer, cause the computer to carry out the steps described herein.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

The steps of any method disclosed herein do not have to be performed in the exact order disclosed, unless explicitly stated or understood by the skilled person.

Corresponding computer programs (which may or may not be recorded on a carrier) for implementing one or more of the methods disclosed herein are also within the present disclosure and encompassed by one or more of the described example embodiments.

The present disclosure includes one or more corresponding aspects, example embodiments or features in isolation or in various combinations whether or not specifically stated (including claimed) in that combination or in isolation. Corresponding means for performing one or more of the discussed functions are also within the present disclosure.

### BRIEF DESCRIPTION OF THE DRAWINGS

The embodiments of the invention are illustrated by way of example, and not by way of limitation, in the figures of the accompanying drawings:

FIG. 1 illustrates a diagram of a system capable of providing predicted tire temperature levels;

FIG. 2 illustrates an example scenario in which a machine learning model renders prediction of tire temperature levels for a target vehicle;

FIG. 3 illustrates an example visual representation indicating an event in which a tire temperature level of a target vehicle is predicted to reach a critical level at a portion of a target route;

FIG. 4 illustrates a partial view of a vehicle equipped with a tire cooling system;

FIG. 5 illustrates a diagram of a database of FIG. 1;

FIG. 6 illustrates a flowchart of a process for training a machine learning model to predict tire temperature levels;

FIG. 7 illustrates a flowchart of a process for providing predicted tire temperature levels;

FIG. 8 illustrates a computer system upon which an embodiment may be implemented;

FIG. 9 illustrates a chip set or chip upon which an embodiment may be implemented; and

FIG. 10 illustrates a diagram of exemplary components of a mobile terminal for communications, which is capable of operating in the system of FIG. 1.

### DETAILED DESCRIPTION

As discussed above, sensing tire temperature levels is essential for determining instances in which said levels reach or exceed critical levels. As tire temperature levels exceed the critical levels for a substantial period of time, the likelihood in which tires of a vehicle sustain permanent damages, such tire explosion, increases. To account for such issue, certain vehicle manufacturers have been installing tire temperature sensors within vehicles to provide real-time tire temperature levels to drivers, thereby enabling the drivers to monitor tire conditions and mitigate vehicle-related hazard. However, since tire temperature sensors are limited to providing real-time values, drivers are notified regarding critical tire temperature levels only when vehicles are traversing in extreme road environments. Additionally, since drivers using vehicles equipped with tire temperature sensors merely receive real-time values of tire temperature levels, drivers cannot plan trips to avoid road segments that induce hazardous conditions for tires of vehicles. Furthermore, tire temperature sensors are not provided in many legacy vehicles. As such, said vehicles are more likely to be impacted by events in which tires of said vehicles sustain critical damages.

Embodiments described herein provide a system that trains a machine learning model for rendering predicted tire temperature levels based on various data associated with vehicles and routes to be traversed by said vehicles. The system includes a prediction platform, where the platform receives training data indicating events in which vehicles traversed routes. The training data include tire temperature levels of the vehicles during the events, vehicle data indicating one or more attributes of the vehicles, map data indicating one or more attributes of the routes, and environmental data indicating one or more attributes of environments of the routes during the events. Once the machine learning model is trained, the prediction platform may receive input data from a user device requesting prediction of tire temperature levels. The input data may include a target route for a target vehicle, one or more attributes associated with the target vehicle, and one or more attributes of the target route. The machine learning model generates output data as a function of the input data, where the output data indicate prediction of one or more tire temperature levels of the target vehicle during a period in which the target vehicle traverses the target route. Details of such embodiments will be described further herein.

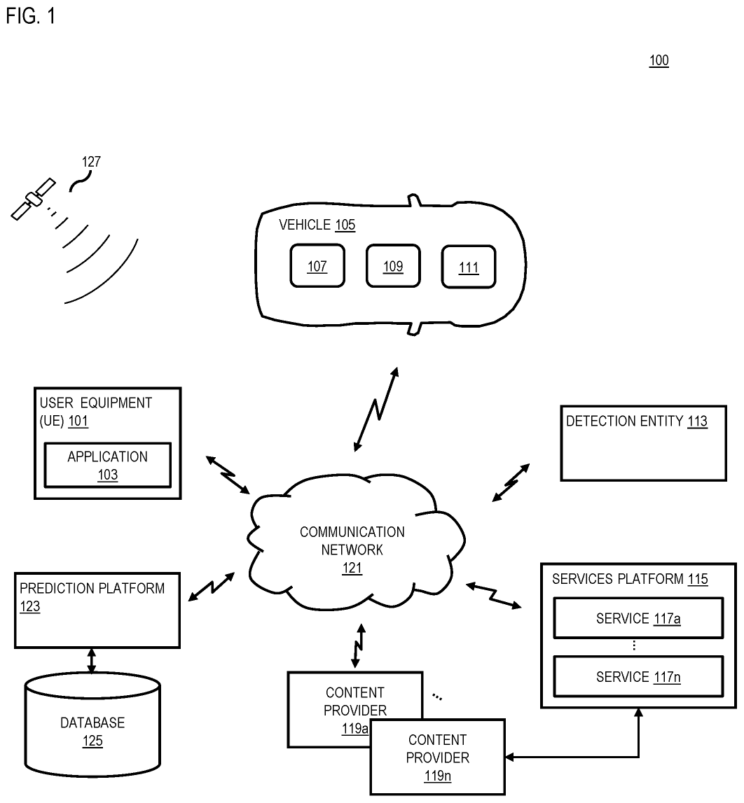

FIG. 1 is a diagram of a system 100 capable of providing predicted tire temperature levels, according to one embodiment. The system includes a user equipment (UE) 101, a vehicle 105, a detection entity 113, a services platform 115, content providers 119a-119n, a communication network 121, a prediction platform 123, a database 125, and a satellite 127. Additional or a plurality of mentioned components may be provided.

In the illustrated embodiment, the system 100 comprises a user equipment (UE) 101 that may include or be associated with an application 103. In one embodiment, the UE 101 has connectivity to the prediction platform 123 via the communication network 121. The prediction platform 123 performs one or more functions associated with providing predicted tire temperature levels. In the illustrated embodiment, the UE 101 may be any type of mobile terminal or fixed terminal such as a mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, devices associated with or integrated with a vehicle (e.g., as part of an infotainment system of the vehicle), or any combination thereof, including the accessories and peripherals of these devices. In one embodiment, the UE 101 can be an in-vehicle navigation system, a personal navigation device (PND), a portable navigation device, a cellular telephone, a mobile phone, a personal digital assistant (PDA), a watch, a camera, a computer, and/or other device that can perform navigation-related functions, such as digital routing and map display. In one embodiment, the UE 101 can be a cellular telephone. A user may use the UE 101 for navigation functions, for example, road link map updates. It should be appreciated that the UE 101 can support any type of interface to the user (such as “wearable” devices, etc.).

In the illustrated embodiment, the application 103 may be any type of application that is executable by the UE 101, such as a mapping application, a location-based service application, a navigation application, a content provisioning service, a camera/imaging application, a media player application, a social networking application, a calendar application, or any combination thereof. In one embodiment, one of the applications 103 at the UE 101 may act as a client for the prediction platform 123 and perform one or more functions associated with the functions of the prediction platform 123 by interacting with the prediction platform 123 over the communication network 121. In one embodiment, the application 103 may be used convey information regarding prediction of tire temperature levels and notifications/suggestions for users to mitigate events in which tires of the user's vehicles reach critical temperature levels.

The vehicle 105 may be a standard gasoline powered vehicle, a hybrid vehicle, an electric vehicle, a fuel cell vehicle, and/or any other mobility implement type of vehicle. The vehicle 105 includes parts related to mobility, such as a powertrain with an engine, a transmission, a suspension, a driveshaft, and/or wheels, etc. The vehicle 105 may be a non-autonomous vehicle or an autonomous vehicle. The term autonomous vehicle may refer to a self-driving or driverless mode in which no passengers are required to be on board to operate the vehicle. An autonomous vehicle may be referred to as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate the vehicle based on the position of the vehicle in order, and may respond to lane marking indicators (lane marking type, lane marking intensity, lane marking color, lane marking offset, lane marking width, or other characteristics) and driving commands or navigation commands. In one embodiment, the vehicle 105 may be assigned with an autonomous level. An autonomous level of a vehicle can be a Level 0 autonomous level that corresponds to a negligible automation for the vehicle, a Level 1 autonomous level that corresponds to a certain degree of driver assistance for the vehicle 105, a Level 2 autonomous level that corresponds to partial automation for the vehicle, a Level 3 autonomous level that corresponds to conditional automation for the vehicle, a Level 4 autonomous level that corresponds to high automation for the vehicle, a Level 5 autonomous level that corresponds to full automation for the vehicle, and/or another sub-level associated with a degree of autonomous driving for the vehicle.

In one embodiment, the UE 101 may be integrated in the vehicle 105, which may include assisted driving vehicles such as autonomous vehicles, highly assisted driving (HAD), and advanced driving assistance systems (ADAS). Any of these assisted driving systems may be incorporated into the UE 101. Alternatively, an assisted driving device may be included in the vehicle 105. The assisted driving device may include memory, a processor, and systems to communicate with the UE 101. In one embodiment, the vehicle 105 may be an HAD vehicle or an ADAS vehicle. An HAD vehicle may refer to a vehicle that does not completely replace the human operator. Instead, in a highly assisted driving mode, a vehicle may perform some driving functions and the human operator may perform some driving functions. Such vehicle may also be driven in a manual mode in which the human operator exercises a degree of control over the movement of the vehicle. The vehicle 105 may also include a completely driverless mode. The HAD vehicle may control the vehicle through steering or braking in response to the on the position of the vehicle and may respond to lane marking indicators (lane marking type, lane marking intensity, lane marking color, lane marking offset, lane marking width, or other characteristics) and driving commands or navigation commands. Similarly, ADAS vehicles include one or more partially automated systems in which the vehicle alerts the driver. The features are designed to avoid collisions automatically. Features may include adaptive cruise control, automate braking, or steering adjustments to keep the driver in the correct lane. ADAS vehicles may issue warnings for the driver based on the position of the vehicle or based on the lane marking indicators (lane marking type, lane marking intensity, lane marking color, lane marking offset, lane marking width, or other characteristics) and driving commands or navigation commands.

In one embodiment, the vehicle 105 includes sensors 107, an on-board communication platform 109, and an on-board computing platform 111. The sensors 107 may include image sensors (e.g., electronic imaging devices of both analog and digital types, which include digital cameras, camera modules, camera phones, thermal imaging devices, radar, sonar, lidar, etc.), a network detection sensor for detecting wireless signals or receivers for different short-range communications (e.g., Bluetooth, Wi-Fi, Li-Fi, near field communication (NFC), etc.), temporal information sensors, an audio recorder for gathering audio data, velocity sensors, light sensors, oriental sensors augmented with height sensor and acceleration sensor, traction sensor, suspension sensor, tilt sensors to detect the degree of incline or decline of the vehicle 105 along a path of travel, etc. In a further embodiment, one or more of the sensors 107 about the perimeter of the vehicle 105 may detect the relative distance of the vehicle 105 from stationary objects (e.g., construct, wall, etc.), road objects, lanes, or roadways, the presence of other vehicles, pedestrians, traffic lights, road features (e.g., curves) and any other objects, or a combination thereof. Said sensors 107 may also detect orientations of such objects. In one embodiment, the vehicle 105 may include GPS receivers to obtain geographic coordinates from satellites 127 for determining current location and time associated with the vehicle 105. Further, the location can be determined by a triangulation system such as A-GPS, Cell of Origin, or other location extrapolation technologies.

The on-board communications platform 109 includes wired or wireless network interfaces to enable communication with external networks. The on-board communications platform 109 also includes hardware (e.g., processors, memory, storage, antenna, etc.) and software to control the wired or wireless network interfaces. In the illustrated example, the on-board communications platform 109 includes one or more communication controllers (not illustrated) for standards-based networks (e.g., Global System for Mobile Communications (GSM), Universal Mobile Telecommunications System (UMTS), Long Term Evolution (LTE) networks, 5G networks, Code Division Multiple Access (CDMA), WiMAX (IEEE 802.16m); Near Field Communication (NFC); local area wireless network (including IEEE 802.11 a/b/g/n/ac or others), dedicated short range communication (DSRC), and Wireless Gigabit (IEEE 802.11ad), etc.). In some examples, the on-board communications platform 109 includes a wired or wireless interface (e.g., an auxiliary port, a Universal Serial Bus (USB) port, a Bluetooth® wireless node, etc.) to communicatively couple with the UE 101.

The on-board computing platform 111 performs one or more functions associated with the vehicle 105. In one embodiment, the on-board computing platform 109 may aggregate sensor data generated by at least one of the sensors 107 and transmit the sensor data via the on-board communications platform 109. The on-board computing platform 109 may receive control signals for performing one or more of the functions from the prediction platform 123, the UE 101, the services platform 115, one or more of the content providers 119a-119n, or a combination thereof via the on-board communication platform 111. The on-board computing platform 111 includes at least one processor or controller and memory (not illustrated). The processor or controller may be any suitable processing device or set of processing devices such as, but not limited to: a microprocessor, a microcontroller-based platform, a suitable integrated circuit, one or more field programmable gate arrays (FPGAs), and/or one or more application-specific integrated circuits (ASICs). The memory may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, non-volatile solid-state memory, etc.), unalterable memory (e.g., EPROMs), read-only memory, and/or high-capacity storage devices (e.g., hard drives, solid state drives, etc). In some examples, the memory includes multiple kinds of memory, particularly volatile memory and non-volatile memory.

The detection entity 113 may be another vehicle, a drone, a user equipment, or a roadside sensor. The detection entity 113 includes one or more image sensors such as electronic imaging devices of both analog and digital types, which include digital cameras, camera modules, camera phones, thermal imaging devices, radar, sonar, lidar, etc. The detection entity 113 may further include a network detection sensor for detecting wireless signals or receivers for different short-range communications (e.g., Bluetooth, Wi-Fi, Li-Fi, near field communication (NFC), etc.), temporal information sensors, an audio recorder for gathering audio data, velocity sensors, light sensors, oriental sensors augmented with height sensor and acceleration sensor, tilt sensors to detect the degree of incline or decline of the detection entity 113 along a path of travel, etc. In one embodiment, the detection entity 113 may include tire temperature sensors and tire pressure sensors. In a further embodiment, sensors about the perimeter of the detection entity 113 may detect the relative distance of the detection entity 113 from road objects, lanes, or roadways, the presence of other vehicles, pedestrians, traffic lights, road features (e.g., curves) and any other objects, or a combination thereof. Said sensors may also detect orientations of such objects. In one embodiment, the detection entity 113 may include GPS receivers to obtain geographic coordinates from satellites 127 for determining current location and time associated with the detection entity 113. Further, the location can be determined by a triangulation system such as A-GPS, Cell of Origin, or other location extrapolation technologies. The detection entity 113 may further include a receiver and a transmitter for maintaining communication with the prediction platform 123 and/or other components within the system 100.

The services platform 115 may provide one or more services 117a-117n (collectively referred to as services 117), such as mapping services, navigation services, travel planning services, weather-based services, emergency-based services, notification services, social networking services, content (e.g., audio, video, images, etc.) provisioning services, application services, storage services, contextual information determination services, location-based services, information-based services, etc. In one embodiment, the services platform 115 may be an original equipment manufacturer (OEM) platform. In one embodiment the one or more service 117 may be sensor data collection services. By way of example, vehicle sensor data provided by the sensors 107 may be transferred to the UE 101, the prediction platform 123, the database 125, or other entities communicatively coupled to the communication network 121 through the service platform 115. In one embodiment, the services platform 115 uses the output data generated by of the prediction platform 123 to provide services such as navigation, mapping, other location-based services, etc.

In one embodiment, the content providers 119a-119n (collectively referred to as content providers 119) may provide content or data (e.g., including geographic data, parametric representations of mapped features, etc.) to the UE 101, the vehicle 105, services platform 115, the vehicle 105, the database 125, the prediction platform 123, or the combination thereof. In one embodiment, the content provided may be any type of content, such as map content, textual content, audio content, video content, image content, etc. In one embodiment, the content providers 119 may provide content that may aid in providing predicted tire temperature levels, and/or other related characteristics. In one embodiment, the content providers 119 may also store content associated with the UE 101, the vehicle 105, services platform 115, the prediction platform 123, the database 125, or the combination thereof. In another embodiment, the content providers 119 may manage access to a central repository of data, and offer a consistent, standard interface to data, such as a repository of the database 125.

The communication network 121 of system 100 includes one or more networks such as a data network, a wireless network, a telephony network, or any combination thereof. The data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, 5G networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In the illustrated embodiment, the prediction platform 123 may be a platform with multiple interconnected components. The prediction platform 123 may include multiple servers, intelligent networking devices, computing devices, components and corresponding software for providing predicted tire temperature levels. It should be appreciated that that the prediction platform 123 may be a separate entity of the system 100, included within the UE 101 (e.g., as part of the applications 103), included within the vehicle 105 (e.g., as part of an application stored in the memory of the on-board computing platform 111), included within the services platform 115 (e.g., as part of an application stored in server memory for the services platform 115), included within the content providers 119 (e.g., as part of an application stored in sever memory for the content providers 119), or a combination thereof.

The prediction platform 123 is capable of: (1) receiving training data indicating events in which vehicles traversed routes; (2) training a machine learning model to output prediction of tire temperature levels; (3) using the trained machine learning model to output prediction of tire temperature levels of a target vehicle during a period in which the target vehicle traverses the target route based on input data indicating a target route for a target vehicle, one or more attributes associated with the target vehicle, and one or more attributes of the target route.

The prediction platform 123 may acquire training data from vehicles (e.g., detection entities 113) that are equipped with tire temperature sensors and have previously traversed routes and recorded data associated with the routes. The training data may also be acquired from non-vehicle types of detection entities 113, such as stationary roadside sensors, drones, etc. The training data include tire temperature levels of vehicles during events in which the vehicles traversed routes, vehicle data indicating one or more attributes of the vehicles, map data indicating one or more attributes of the routes, and environmental data indicating one or more attributes of environments of the routes during the events.

The tire temperature levels may indicate temperature levels of a specific portion of a tire. By way of example, the tire temperature levels may indicate temperature levels of a surface of the tire, ambient temperature levels within the tire, or a combination thereof. The tire temperature levels may be indicative of data collected over the entire durations in which the vehicle have traversed the routes.

The one or more attributes of the vehicles indicates: (1) speed levels of the vehicles; (2) acceleration or deceleration levels of the vehicles; (3) total distance travelled by each of the vehicles; (4) tire pressure levels of the vehicles; (5) specifications of the vehicles; (6) specifications of wheels of the vehicles (e.g., tire temperature grades); (7) specifications of tires of the vehicles; (8) age of each of the vehicles; (9) age of each tire of the vehicles; (10) loads of the vehicles; or (11) a combination thereof. In one embodiment, certain attributes of a vehicle may be recorded over a portion of a route traversed by the vehicle or a window of time within a period in which the vehicle traversed the route. For example, speed levels, acceleration/deceleration levels, and/or tire pressure levels of a vehicle may be recorded over one or more road segments, one or more nodes, or a combination of road segments and nodes. In one embodiment, the total distance travelled by each of the vehicles may indicate the total distance of the route, an amount of distance travelled by said vehicle for a predetermined amount of period, or the mileage of said vehicle. In one embodiment, the loads of the vehicles may indicate, for each of the vehicles, a distribution of weight on the vehicle. In one embodiment, the one or more attributes of the vehicles may indicate a resting angle of the body of the vehicle with respect to wheels of the vehicle.

The one or more attributes of the routes indicates: (1) a road surface type; (2) a road surface condition; (3) a functional class; (4) a curvature; (5) a degree of traffic; (6) a number of tire-related accidents that have occurred; or (7) a combination thereof. The road surface type may indicate the composition of the road surface of each of the routes (e.g., asphalt, concrete, dirt, etc.). The road surface may condition may indicate the condition of the road surface of each of the routes (e.g., formation of potholes, cracks, etc.). A functional class of a road defines a function of the road within a transportation system. In one embodiment, a functional class of a road may be described as a numerical value (e.g., 1, 2, 3, 4, and 5). Functional class 1 may be interstates while functional class 5 may be local roads. One example of a simple system includes the functional classification maintained by the United States Federal Highway administration. The simple system includes arterial roads, collector roads, and local roads. The functional classifications of roads balance between accessibility and speed. An arterial road has low accessibility but is the fastest mode of travel between two points. Arterial roads are typically used for long distance travel. Collector roads connect arterial roads to local roads. Collector roads are more accessible and slower than arterial roads. Local roads are accessible to individual homes and business. Local roads are the most accessible and slowest type of road. An example of a complex functional classification system is the urban classification system. Interstates include high speed and controlled access roads that span long distances. The arterial roads are divided into principle arteries and minor arteries according to size. The collector roads are divided into major collectors and minor collectors according to size. Another example functional classification system divides long distance roads by type of road or the entity in control of the highway. The functional classification system includes interstate expressways, federal highways, state highways, local highways, and local access roads. Another functional classification system uses the highway tag system in the Open Street Map (OSM) system. The functional classification includes motorways, trunk roads, primary roads, secondary roads, tertiary roads, and residential roads. The curvature may indicate a curvature of a portion of each of the routes (e.g., a road segment, multiple road segment, or a portion of a road segment). The degree of traffic may be indicative of traffic at a portion of the route in which the vehicle was traversing at a given instance. The degree of traffic may indicate a current traffic condition for said portion or a historical traffic condition at said portion for a given instance. Tire related-accidents may indicate a number of incidents in which one or more tires of a vehicle have been damaged within a given route (e.g., tire explosion).

The one or more attributes of the environments of the routes indicates: (1) air temperature levels; (2) humidity levels; (3) pavement temperature levels; (4) precipitation; (5) solar radiation levels; (6) wind direction and intensity levels; or (7) a combination thereof. The air temperature levels, humidity levels, precipitation, solar radiation levels, and wind direction and intensity levels may indicate variables of environments local to all portions of each of the routes and during instances in which a corresponding vehicle among the vehicles was traversing each portion of said route. The precipitation of each of the routes may indicate: (1) a type of precipitation formed within one or more portions of said route; (2) an amount of precipitation formed within one or more portions of said route; (3) an amount of precipitation that was forming within one or more portion of said route at one or more periods; (4) a location of precipitation formed within said route; or (5) a combination thereof.

The machine learning model receives the training data and transforms the training data into machine-readable and generalizable vectors. The machine learning model renders context around the training data such that commonalities can be detected. Once the machine learning model translates the training data into a vector format suitable to be used as a feature vector for machine learning, the prediction platform 123 trains the machine learning model on resulting pairs (i.e., observations as seen in the training data and desired output value). For example, a desired output value may be defined by a tire temperature level for a given instance of time (e.g., current time or a future time) or one or more tire temperature levels for a given period, and observations may be defined by aggregating all occurrences of past events in which tire temperature levels of a vehicle were recorded on a particular road segment during a particular setting (e.g., all occurrences having the same vector representation). In one embodiment, the machine learning model may incorporate supervised machine learning techniques. In one embodiment, the machine learning model may incorporate a standard regression or classification task.

It is contemplated that a single machine learning model may be used to output a predicted tire temperature level for a vehicle, and said predicted tire temperature level may be representative of all tire temperature levels of all wheels of the vehicle. However, it is further contemplated that attributes associated with each wheel of the vehicle may differ from each other (e.g., age of one tire may differ from another tire or load distribution of the vehicle may cause faster tire deterioration for certain tires of the vehicle). As such, a single machine learning model outputs a single point of failure for all tires of a vehicle, and one or more true states of one or more tires of the vehicle may be misrepresented. To remedy such issue, the prediction platform 123 may establish a machine learning model for each wheel of a vehicle, and each machine learning model may use attributes unique to each wheel of the vehicle and generate prediction of tire temperature levels for said wheel of the vehicle.

Once the machine learning model is trained, the machine learning model may receive input data indicating a target route for a target vehicle (e.g., vehicle 105), one or more attributes associated with the target vehicle, and one or more attributes of the target route and output prediction of one or more tire temperature levels of the target vehicle during a period in which the target vehicle traverses the target route. Herein, a “target” modifier refers to an object of which prediction is rendered for or an object/data used for rendering the prediction. The input data may be provided through the UE 101 via the application 103 or the vehicle 105. It is contemplated that the vehicle 105 may or may not include a tire temperature sensor. Since the machine learning model is trained based on training data acquired from vehicles equipped with tire temperature sensors, the process in which the trained machine learning model renders prediction of tire temperature levels for a target vehicle can be performed without necessitating data provided from tire temperature sensors equipped by the target vehicle. Similar to the training data, the one or more attributes associated with the target vehicle that is included within the input data may indicate: (1) current speed level of the target vehicle; (2) current rate of acceleration or deceleration level of the target vehicle; (3) total distance travelled by the target vehicle; (4) current tire pressure level of the target vehicle; (5) specifications of the target vehicle; (6) specifications of wheels of the target vehicle; (7) specifications of tires of the target vehicle; (8) age of each of the target vehicle; (9) age of each tire of the target vehicle; (10) load of the target vehicle; or (11) a combination thereof. Further, the one or more attributes associated with the target route may indicate: (1) a road surface type; (2) a road surface condition; (3) a functional class; (4) a curvature; (5) a degree of traffic; (6) a number of tire-related accidents that have occurred; (7) air temperature levels at the target route; (8) humidity levels at the target route; (9) pavement temperature levels at the target route; (10) precipitation within the target route; (11) solar radiation levels of the target route; (12) wind direction and intensity levels at the target route; or (13) a combination thereof. The one or more attributes associated with the target vehicle and the one or more attributes associated with the target route may be acquired by the UE 101, the vehicle 105, one or more detection entities 113 within the target route or was within the target route, the services platform 115, the content providers 119, the database 125, or a combination thereof. In one embodiment, the prediction indicates a current tire temperature level of the target vehicle. In such embodiment, the prediction is rendered based on real-time data or near real-time data (e.g., current speed level of the target vehicle). In one embodiment, the prediction indicates one or more tire temperature levels of the target vehicle at one or more portions of the target route. If the one or more portions is one or more locations of which the target vehicle has not currently reached but is designated to reach in time, certain attributes used for rendering the prediction are calculated as a function of predicted time points at which the target vehicle is estimated to reach said locations. For example, the prediction platform 123 may estimate that the target vehicle will reach a portion within the target route at an estimated time point based on traffic data associated with the target route. In such example, the prediction platform 123 uses the estimated time point to further predict a weather condition corresponding to the estimated time point at the portion based on weather forecast data. Data indicating the predicted weather condition will be used as an attribute of the portion of the target route for rendering prediction of a tire temperature level at the portion of the target route. If the one or more portions is one or more locations of which the target vehicle has already traversed, the prediction is rendered based on past data.

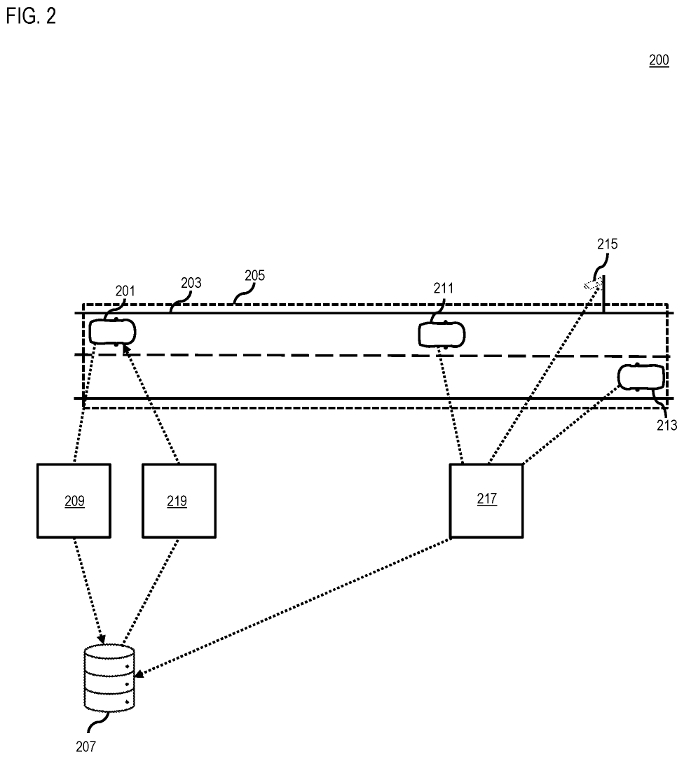

FIG. 2 illustrates an example scenario 200 in which a machine learning model renders prediction of tire temperature levels for a target vehicle. In the illustrated example, a target vehicle 201 is traversing a road link 203 and generates a request for rendering prediction of tire temperature levels of the target vehicle 201 while the target vehicle 201 traverses a portion 205 of a target route. The target vehicle 201 transmits to a server 207 a first data packet 209 including the request and one or more attributes associated with the target vehicle 201. A first vehicle 211 and a second vehicle 213 are also traversing the road link 203 and include sensors for identifying one or more attributes associated with the portion 205. A roadside sensor 215 is also disposed within a peripheral of the road link 203 and obtains one or more attributes associated with the portion 205. In the illustrated example, the first vehicle 211, the second vehicle 213, and the roadside sensors 215 include sensors such as image sensors, thermal sensors, and solar radiation sensors. As such, the one or more attributes associated with the portion 205 may be road surface condition, degree of traffic, air temperature levels at the portion 205, pavement temperature levels at the portion 205, or a combination thereof. The one or more attributes of the portion 205 is defined in second data packets 217, and the second data packets 217 are transmitted to the server 207. The server 207 may be the prediction platform 123 and input the first data packet 209 and the second data packet 217 to a machine learning model. In response, the machine learning model outputs prediction of one or more tire temperature levels of the vehicle 201, and the server 207 transmits a third data packet 219 including the prediction to the target vehicle 201. The prediction may indicate a current tire temperature level of the target vehicle 201 or one or more tire temperature levels at one or more subsequent locations within the portion 205.

Returning to FIG. 1, the prediction platform 123 utilizes outputs of the machine learning model to provide various applications. In one embodiment, the prediction platform 123 uses the output of the machine learning model to generate a roadmap of tire temperature levels for a target vehicle. In such embodiment, the roadmap partitions a target route of the target vehicle into segments, and each segment indicate a predicted tire temperature level at a period in which the target vehicle traverses said segment. In one embodiment, the prediction platform 123 compares each predicted tire temperature level of each segment to a threshold tire temperature level, and if the prediction platform 123 determines that said predicted tire temperature level will exceed the threshold, the prediction platform 123 generates a notification/suggestion for mitigating adverse conditions associated with the target route of the target vehicle.

In one embodiment, the prediction platform 123 generates a notification indicating that a tire temperature level of a tire of the target vehicle will reach a critical level at a certain portion of the target route. In one embodiment, the prediction platform 123: (1) uses map data to identify alternative routes to a destination; (2) uses the machine learning model to generate a roadmap of tire temperature levels for each alternative route; and (3) provide recommendations/suggestions for using each alternative route, where tire temperature levels of said alternative route is lower than the threshold tire temperature level.

In one embodiment, the prediction platform 123: (1) uses the machine learning model to generate roadmaps of tire temperature levels for a target route at various periods; (2) determine periods in which roadmaps of tire temperature levels for the target route is lower than the threshold tire temperature level; and (3) provide recommendations indicating periods in which the target vehicle should traverse the target route based on the determination. For example, the prediction platform 123 may predict that a tire temperature level of a target vehicle will exceed a threshold tire temperature level at a specific portion of a target route if the target vehicle begins to traverse the target route at 2:00 PM. Using the predictions, the prediction platform 123 determines that the tire temperature level of the target vehicle will not exceed the threshold tire temperature level at said portion of the target route if the target vehicle begins to traverse the target route at 2:20 PM, and the prediction platform 123 provides a recommendation for the target vehicle to begin traversing the target route at 2:20 PM.

In one embodiment, in addition to comparing a predicted tire temperature level associated with a target route to the threshold tire temperature, the prediction platform 123 estimates a duration in which the tire temperature level exceeds the threshold tire temperature. If the estimated duration is less than a threshold duration, the prediction platform 123 may recommend the target route to the user of the target vehicle; however, if the estimated duration is greater than the threshold duration, the prediction platform 123 does not recommend the target route.

In one embodiment, if the prediction platform 123 determines that a target vehicle is traversing a target route and predicts that a tire temperature is exceeding or will exceed a threshold tire temperature level at a specific portion of the target route, the prediction platform 123 may provide a recommendation for a user of the target vehicle to slow down or temporary stop the target vehicle at the specific portion or other portions within the target route that precedes or follows the specific portion.

In one embodiment, if the prediction platform 123 determines that a target vehicle is traversing a target route and predicts that a tire temperature is exceeding or will exceed a threshold tire temperature level at a portion of the target route, the prediction platform 123 acquires sensor data (e.g., image data) acquired by one or more detection entities 113 that is within or was proximate to the portion of the target route and uses the sensor data to determine whether the target route is proximate to at least one road segment in which precipitation has formed (e.g., a puddle). If said road segment exists, the prediction platform 123 generates a recommendation for a user of the target vehicle to traverse through said road segment to lower the tire temperature level of the target vehicle (e.g., by causing the target vehicle to drive over the puddle).

In one embodiment, if the prediction platform 123 determines that a target vehicle is traversing a target route and predicts that a tire temperature is exceeding or will exceed a threshold tire temperature level at a portion of the target route, the prediction platform 123 acquires sensor data (e.g., image data) acquired by one or more detection entities 113 that is within or was proximate to the portion of the target route and uses the sensor data to determine whether the target route is proximate to at least one road segment in which a shadow is cast. Alternatively, the prediction platform 123 may also estimate formation of shadows in locations proximate to the target route based on attributes of location (e.g., orientation and positions of buildings in said location, angle of the sun with respect said location, area of shadow cast in said location based on the angle of the sun and the orientation of the buildings, etc.). If said road segment exists, the prediction platform 123 generates a recommendation for a user of the target vehicle to traverse through said road segment to lower the tire temperature level of the target vehicle (e.g., by causing the target vehicle to drive over areas in which the shadow is cast).

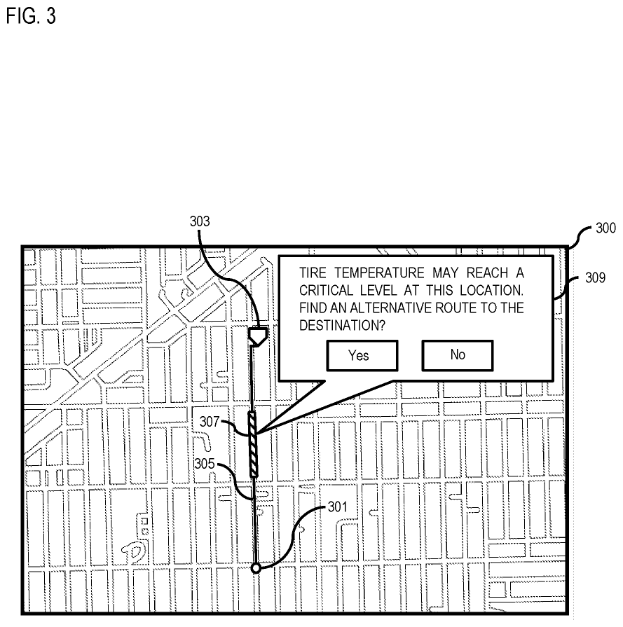

As discussed above, the prediction platform 123 is capable of generating notifications and/or other types of information based on an output of the machine learning model. The prediction platform 123 may transmit the notifications to the UE 101 and/or a user interface associated with the vehicle 105. The notification may include sound notification, display notification, vibration, or a combination thereof. In one embodiment, the prediction platform 123 may cause the UE 101 and/or the user interface associated with the vehicle 105 to generate a visual representation indicating the output of the machine learning model. For example, FIG. 3 illustrates an example visual representation 300 indicating an event in which a tire temperature level of a target vehicle is predicted to reach a critical level at a portion of a target route. In the illustrated example, the visual representation 300 displays a map including an avatar 301 indicating a current location of a target vehicle, a destination 303, a target route 305 to the destination 303, and a highlighted section 307 of the target route 305. Based on attributes of the target vehicle and target route 305, the machine learning model has generated output data indicating that the tire temperature level of the target vehicle will reach a critical level at the highlighted section 307 when the vehicle traverses the location of the highlighted section 307. As such, the visual representation includes a message prompt 309 stating “TIRE TEMPERATURE MAY REACH A CRITICAL LEVEL ΔT THIS LOCATION. FIND ΔN ALTERNATIVE ROUTE TO THE DESTINATION?”.

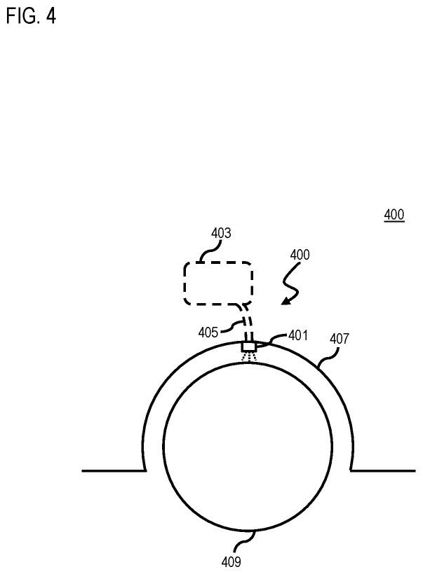

It is contemplated that certain vehicles may be equipped with a system for directly cooling tires of the vehicles. For example, FIG. 4 illustrates a partial view 400 of a vehicle equipped with a tire cooling system. In the illustrated example, a tire cooling system 400 includes a liquid dispensing device 401, a reservoir 403, and a medium 405. The liquid dispensing device 401 may be installed on a wheel well 407 of the vehicle and dispense liquid towards a tire 409 of the vehicle. The liquid dispensing device 401 may be communicatively coupled to an electronic control unit (not illustrated) of the vehicle may be controlled to dispense liquid towards the tire 409 of the vehicle based on a control signal received from the electronic control unit. The reservoir 403 may store liquid (e.g., water) for cooling the tire 409. The medium 405 may fluidly connect the reservoir 403 and the liquid dispensing device 401. In one embodiment, vehicles equipped with tire cooling systems, such as the example vehicle and the example tire cooling system as described with respect to FIG. 4, may receive control signals for cooling tires of the vehicles based on predictions rendered by the prediction platform 123. For example, a target vehicle may be a vehicle equipped with a tire cooling system, such as the example vehicle and the example tire cooling system as described with respect to FIG. 4. In such example, if the prediction platform 123 determines that the target vehicle is traversing a target route and predicts that a tire temperature level of the target vehicle is exceeding or will exceed a threshold tire temperature level at a portion of the target route, the prediction platform 123 may cause or provide suggestion for the target vehicle to activate the tire cooling system (e.g., causing the tire cooling system to dispense liquid). In such example, the prediction platform 123 may cause or provide suggestion for the target vehicle to activate the tire cooling system when: (1) the target vehicle is currently traversing the portion of the target route; or (2) the target vehicle is about to traverse the portion of the target route (e.g., within 10-20 meters from the portion). Since predictions rendered by the prediction platform 123 enable vehicles, such as the example vehicle and the example tire cooling system as described with respect to FIG. 4, to strategically activate tire cooling systems, resources spent by the tire cooling systems can be saved.

The prediction platform 123 can be implemented in hardware, firmware, software, or a combination thereof. Though depicted as a separate entity in FIG. 1, it is contemplated that the prediction platform 123 may be implemented for direct operation by the UE 101, the vehicle 105, the services platform 115, one or more of the content providers 119, or a combination thereof. As such, the prediction platform 123 may generate direct signal inputs by way of the operating system of the UE 101, the vehicle 105, the services platform 115, the one or more of the content providers 119, or the combination thereof for interacting with the applications 103. The various executions presented herein contemplate any and all arrangements and models.

In the illustrated embodiment, the database 125 stores information on road links (e.g., road length, road breadth, slope information, curvature information, geographic attributes, etc.), probe data for one or more road links (e.g., traffic density information), POIs, and other types map-related features. In one embodiment, the database 125 may include any multiple types of information that can provide means for aiding in providing predicted tire temperature levels. It should be appreciated that the information stored in the database 125 may be acquired from any of the elements within the system 100, other vehicles, sensors, database, or a combination thereof.

In one embodiment, the UE 101, the vehicle 105, the detection entity 113, the services platform 115, the content providers 119, the prediction platform 123 communicate with each other and other components of the communication network 121 using well known, new or still developing protocols. In this context, a protocol includes a set of rules defining how the network nodes within the communication network 121 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically affected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

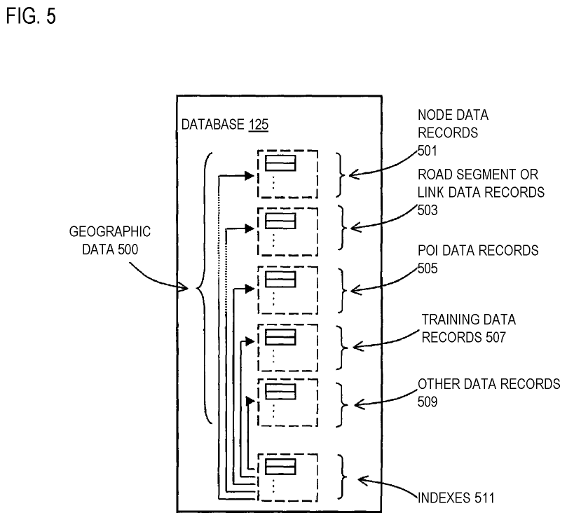

FIG. 5 is a diagram of a database 125 (e.g., a map database), according to one embodiment. In one embodiment, the database 125 includes data 500 used for (or configured to be compiled to be used for) mapping and/or navigation-related services, such as for personalized route determination, according to exemplary embodiments.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions, models, routes, etc. Accordingly, the terms polygons and polygon extrusions/models as used herein can be used interchangeably.

In one embodiment, the following terminology applies to the representation of geographic features in the database 125.

“Node”—A point that terminates a link.

“Line segment”—A line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the database 125 follows certain conventions. For example, links do not cross themselves and do not cross each other except at a node or vertex. Also, there are no duplicated shape points, nodes, or links. Two links that connect each other have a common node or vertex. In the database 125, overlapping geographic features are represented by overlapping polygons. When polygons overlap, the boundary of one polygon crosses the boundary of the other polygon. In the database 125, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

In one embodiment, the database 125 is presented according to a hierarchical or multilevel tile projection. More specifically, in one embodiment, the database 125 may be defined according to a normalized Mercator projection. Other projections may be used. In one embodiment, a map tile grid of a Mercator or similar projection can a multilevel grid. Each cell or tile in a level of the map tile grid is divisible into the same number of tiles of that same level of grid. In other words, the initial level of the map tile grid (e.g., a level at the lowest zoom level) is divisible into four cells or rectangles. Each of those cells are in turn divisible into four cells, and so on until the highest zoom level of the projection is reached.

In one embodiment, the map tile grid may be numbered in a systematic fashion to define a tile identifier (tile ID). For example, the top left tile may be numbered 00, the top right tile may be numbered 01, the bottom left tile may be numbered 10, and the bottom right tile may be numbered 11. In one embodiment, each cell is divided into four rectangles and numbered by concatenating the parent tile ID and the new tile position. A variety of numbering schemes also is possible. Any number of levels with increasingly smaller geographic areas may represent the map tile grid. Any level (n) of the map tile grid has 2(n+1) cells. Accordingly, any tile of the level (n) has a geographic area of A/2(n+1) where A is the total geographic area of the world or the total area of the map tile grids. Because of the numbering system, the exact position of any tile in any level of the map tile grid or projection may be uniquely determined from the tile ID.

As shown, the database 125 includes node data records 501, road segment or link data records 503, POI data records 505, training data records 507, other records 509, and indexes 511, for example. More, fewer or different data records can be provided. In one embodiment, additional data records (not shown) can include cartographic (“carto”) data records, routing data, and maneuver data. In one embodiment, the indexes 511 may improve the speed of data retrieval operations in the database 125. In one embodiment, the indexes 511 may be used to quickly locate data without having to search every row in the database 125 every time it is accessed.

In exemplary embodiments, the road segment or link data records 503 are links or segments representing roads, streets, or paths, as can be used in the calculated route or recorded route information for determination of one or more personalized routes. The node data records 501 are end points (such as intersections) corresponding to the respective links or segments of the road segment data records 503. The road segment or link data records 503 and the node data records 501 represent a road network, such as used by vehicles, cars, and/or other entities. Alternatively, the database 125 can contain path segment and node data records or other data that represent pedestrian paths or areas in addition to or instead of the vehicle road record data, for example. In one embodiment, the road or path segments can include an altitude component to extend to paths or road into three-dimensional space (e.g., to cover changes in altitude and contours of different map features, and/or to cover paths traversing a three-dimensional airspace).

Links, segments, and nodes can be associated with attributes, such as geographic coordinates, road surface type, road surface condition, functional class, curvature, degree of traffic, number and types of accidents that have occurred, a number of road objects (e.g., road markings, road signs, traffic light posts, etc.), types of road objects, traffic directions, street names, address ranges, speed limits, turn restrictions at intersections, presence of roadworks, and other navigation related attributes, as well as POIs, such as gasoline stations, hotels, restaurants, museums, stadiums, offices, automobile dealerships, auto repair shops, factories, buildings, stores, parks, etc. The database 125 can include data about the POIs and their respective locations in the POI data records 505. The database 125 can also include data about places, such as cities, towns, or other communities, and other geographic features, such as bodies of water, mountain ranges, etc. Such place or feature data can be part of the POI data records 505 or can be associated with POIs or POI data records 505 (such as a data point used for displaying or representing a position of a city).

The training data records 507 include tire temperature levels of vehicles during events in which the vehicles traversed routes, vehicle data indicating one or more attributes of the vehicles, map data indicating one or more attributes of the routes, and environmental data indicating one or more attributes of environments of the routes during the events. The tire temperature levels may indicate tire temperatures within a specific portion of a tire or a specific area within the tire. The one or more attributes of the vehicles indicates: (1) speed levels of the vehicles; (2) acceleration or deceleration levels of the vehicles; (3) total distance travelled by each of the vehicles; (4) tire pressure levels of the vehicles; (5) specifications of the vehicles; (6) specifications of wheels of the vehicles (e.g., tire temperature grades); (7) specifications of tires of the vehicles; (8) age of each of the vehicles; (9) age of each tire of the vehicles; (10) loads of the vehicles; or (11) a combination thereof. The one or more attributes of the routes indicates: (1) a road surface type; (2) a road surface condition; (3) a functional class; (4) a curvature; (5) a degree of traffic; (6) a number of tire-related accidents that have occurred; or (7) a combination thereof. The one or more attributes of the environments of the routes indicates: (1) air temperature levels; (2) humidity levels; (3) pavement temperature levels; (4) precipitation; (5) solar radiation levels; (6) wind direction and intensity levels; or (7) a combination thereof.

Other data records 509 may include algorithms defining one or more machine learning models for rendering prediction of tire temperature levels.

In one embodiment, the database 125 can be maintained by the services platform 115 and/or one or more of the content providers 119 in association with a map developer. The map developer can collect geographic data to generate and enhance the database 125. There can be different ways used by the map developer to collect data. These ways can include obtaining data from other sources, such as municipalities or respective geographic authorities. In addition, the map developer can employ field personnel to travel by vehicle along roads throughout the geographic region to observe attributes associated with one or more road segments and/or record information about them, for example. Also, remote sensing, such as aerial or satellite photography, can be used.

The database 125 can be a master database stored in a format that facilitates updating, maintenance, and development. For example, the master database or data in the master database can be in an Oracle spatial format or other spatial format (e.g., accommodating different map layers), such as for development or production purposes. The Oracle spatial format or development/production database can be compiled into a delivery format, such as a geographic data files (GDF) format. The data in the production and/or delivery formats can be compiled or further compiled to form database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by the vehicle 105, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received database in a delivery format to produce one or more compiled navigation databases.

The processes described herein for providing predicted tire temperature levels may be advantageously implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof.

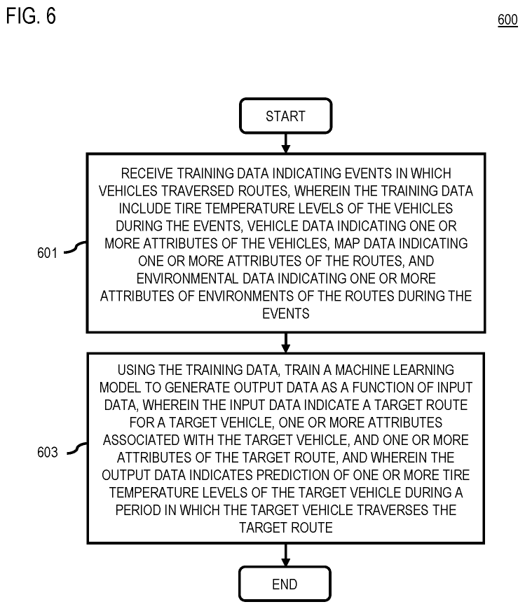

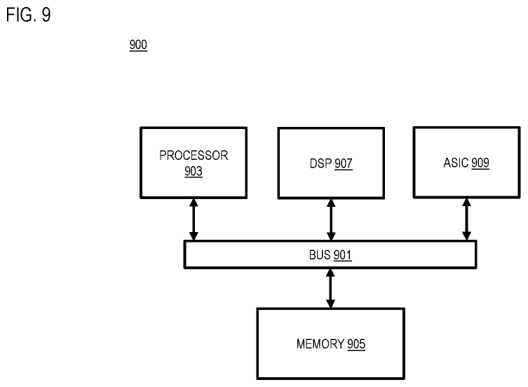

FIG. 6 is a flowchart of a process 600 for training a machine learning model to predict tire temperature levels, according to one embodiment. In one embodiment, the prediction platform 123 performs the process 500 and is implemented in, for instance, a chip set including a processor and a memory as shown in FIG. 9.

In step 601, the prediction platform 123 receives training data indicating events in which vehicles traversed routes. The training data include tire temperature levels of the vehicles during the events, vehicle data indicating one or more attributes of the vehicles, map data indicating one or more attributes of the routes, and environmental data indicating one or more attributes of environments of the routes during the events. The one or more attributes of the vehicles may indicate: (1) speed levels of the vehicles; (2) acceleration or deceleration levels of the vehicles; (3) total distance travelled by each of the vehicles; (4) tire pressure levels of the vehicles; (5) specifications of the vehicles; (6) specifications of wheels of the vehicles; (7) specifications of tires of the vehicles; (8) age of each of the vehicles; (9) age of each tire of the vehicles; (10) loads of the vehicles, or (11) a combination thereof. The one or more attributes of the routes may indicate: (1) a road surface type; (2) a road surface condition; (3) a functional class; (4) a curvature; (5) a degree of traffic; or (6) a combination thereof. The one or more attributes of the environments of the routes may indicate: (1) air temperature levels; (2) humidity levels; (3) pavement temperature levels; (4) precipitation; (5) solar radiation levels; (6) wind direction and intensity levels; or (7) a combination thereof. The prediction platform 123 may acquire the training data from vehicles (e.g., detection entities 113) that are equipped with tire temperature sensors, have previously traversed routes, and have recorded data associated with the routes. The training data may also be acquired from non-vehicle types of detection entities 113, such as stationary roadside sensors, drones, etc.

In step 603, the prediction platform 123 trains a machine learning model to generate output data as a function of input data by using the training data. The input data indicate a target route for a target vehicle, one or more attributes associated with the target vehicle, and one or more attributes of the target route. The output data indicate prediction of one or more tire temperature levels of the target vehicle during a period in which the target vehicle traverses the target route. Specifically, the machine learning model receives the training data and transforms the training data into machine-readable and generalizable vectors. The machine learning model renders context around the training data such that commonalities can be detected. Once the machine learning model translates the training data into a vector format suitable to be used as a feature vector for machine learning, the prediction platform 123 trains the machine learning model on resulting pairs (i.e., observations as seen in the training data and desired output value). For example, a desired output value may be defined by a tire temperature level for a given instance of time (e.g., current time or a future time) or one or more tire temperature levels for a given period, and observations may be defined by aggregating all occurrences of past events in which tire temperature levels of a vehicle were recorded on a particular road segment during a particular setting (e.g., all occurrences having the same vector representation). In one embodiment, the machine learning model may incorporate supervised machine learning techniques. In one embodiment, the machine learning model may incorporate a standard regression or classification task.

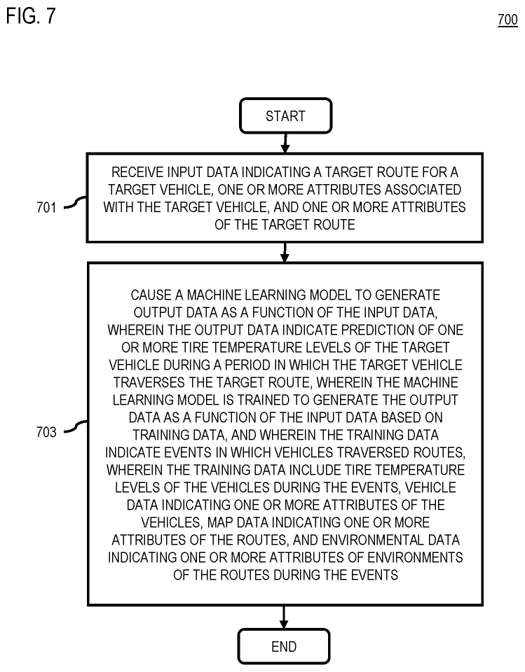

FIG. 7 is a flowchart of a process 700 for providing predicted tire temperature levels, according to one embodiment. In one embodiment, the prediction platform 123 performs the process 700 and is implemented in, for instance, a chip set including a processor and a memory as shown in FIG. 9.

In step 701, the prediction platform 123 receives input data indicating a target route for a target vehicle, one or more attributes associated with the target vehicle, and one or more attributes of the target route. Such data may be acquired by the target vehicle (e.g., vehicle 105), one or more detection entities 113 within the target route or was within the target route, the services platform 115, the content providers 119, the database 125, or a combination thereof.

In step 703, the prediction platform 123 causes a machine learning model to generate output data as a function of the input data. The output data indicate prediction of one or more tire temperature levels of the target vehicle during a period in which the target vehicle traverses the target route. The machine learning model is trained to generate the output data as a function of the input data based on training data. The training data indicate events in which vehicles traversed routes. The training data may include tire temperature levels of the vehicles during the events, vehicle data indicating one or more attributes of the vehicles, map data indicating one or more attributes of the routes, and environmental data indicating one or more attributes of environments of the routes during the events. The prediction may be used to provide suggestions/notifications for drivers to mitigate instances in which tires of the target vehicle reach critical levels. Such suggestions/notifications may indicate alternative routes, alternative departure time for traversing the target route, etc.

The system, apparatus, and methods described herein reliably predicts tire temperature levels thereby enabling drivers to plan trips thereof to mitigate instances in which vehicle tires sustain permanent/critical damages due to excessive heat. Additionally, the system, apparatus, and methods described herein are capable of informing tire temperature levels of vehicles that do not typically include tire temperature sensors, thereby enabling drivers of said vehicles to monitor tire temperature levels of the vehicles and safely maneuver the vehicles based on the tire temperature levels.

The processes described herein may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

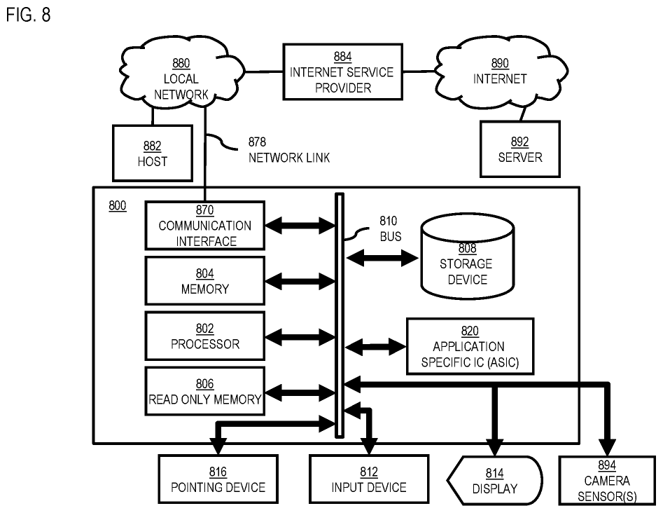

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to predict tire temperature levels as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of providing predicted tire temperature levels.

A bus 810 includes one or more parallel conductors of information so that information is transferred quickly among devices coupled to the bus 810. One or more processors 802 for processing information is coupled with the bus 810.

A processor (or multiple processors) 802 performs a set of operations on information as specified by computer program code related to providing predicted tire temperature levels. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and ΔND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 800 also includes a memory 804 coupled to bus 810. The memory 804, such as a random access memory (RAM) or any other dynamic storage device, stores information including processor instructions for providing predicted tire temperature levels. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for providing predicted tire temperature levels, is provided to the bus 810 for use by the processor from an external input device 812, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814, and one or more camera sensors 894 for capturing, recording and causing to store one or more still and/or moving images (e.g., videos, movies, etc.) which also may comprise audio recordings. In some embodiments, for example, in embodiments in which the computer system 800 performs all functions automatically without human input, one or more of external input device 812, display device 814 and pointing device 816 may be omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 121 for providing predicted tire temperature levels to the UE 101.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 882 connected to the Internet hosts a process that provides a service in response to information received over the Internet. For example, server host 882 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 882 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set or chip 900 upon which an embodiment of the invention may be implemented. Chip set 900 is programmed to predict tire temperature levels as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of providing predicted tire temperature levels.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real-time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 900 includes merely one or more processors and some software and/or firmware supporting and/or relating to and/or for the one or more processors. The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to predict tire temperature levels. The memory 905 also stores the data associated with or generated by the execution of the inventive steps.

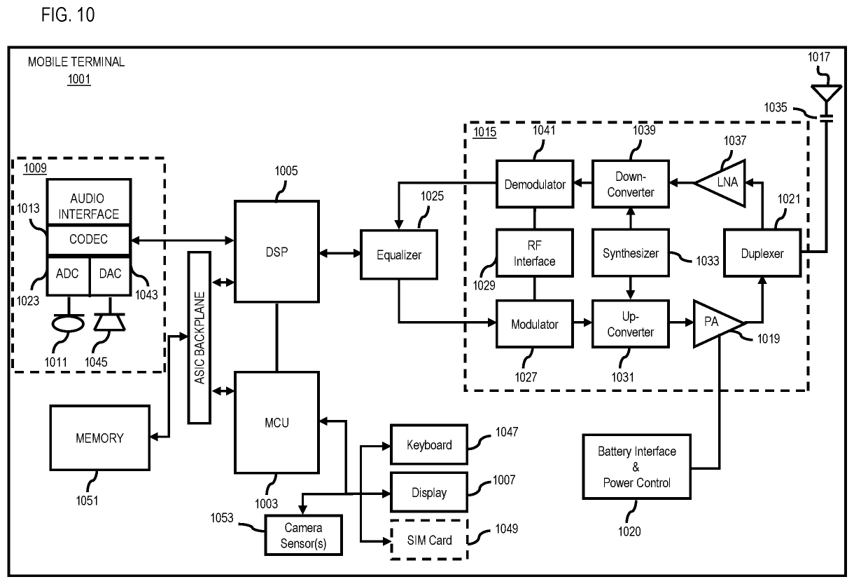

FIG. 10 is a diagram of exemplary components of a mobile terminal 1001 (e.g., a mobile device or vehicle or part thereof) for communications, which is capable of operating in the system of FIG. 1, according to one embodiment. In some embodiments, mobile terminal 1001, or a portion thereof, constitutes a means for performing one or more steps of providing predicted tire temperature levels. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of providing predicted tire temperature levels. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (ΔGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to predict tire temperature levels. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

Further, one or more camera sensors 1053 may be incorporated onto the mobile station 1001 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

We (I) claim:

1. An apparatus comprising at least one processor and at least one non-transitory memory including computer program code instructions, the computer program code instructions configured to, when executed, cause the apparatus to:
receive training data indicating events in which vehicles traversed routes, wherein the training data include tire temperature levels of the vehicles during the events, vehicle data indicating one or more attributes of the vehicles, map data indicating one or more attributes of the routes, and environmental data indicating one or more attributes of environments of the routes during the events; and
using the training data, train a machine learning model to generate output data as a function of input data, wherein the input data indicate a target route for a target vehicle, one or more attributes associated with the target vehicle, and one or more attributes of the target route, and wherein the output data indicate prediction of one or more tire temperature levels of the target vehicle during a period in which the target vehicle traverses the target route.

2. The apparatus of claim 1, wherein the input data does not include tire temperature levels of the target vehicle.

3. The apparatus of claim 1, wherein the one or more attributes of the vehicles indicates: (i) speed levels of the vehicles; (ii) acceleration or deceleration levels of the vehicles; (iii) total distance travelled by each of the vehicles; (iv) tire pressure levels of the vehicles; (v) specifications of the vehicles; (vi) specifications of wheels of the vehicles; (vii) specifications of tires of the vehicles; (viii) age of each of the vehicles; (ix) age of each tire of the vehicles; (x) loads of the vehicles; or (xi) a combination thereof.

4. The apparatus of claim 1, wherein the one or more attributes of the routes indicates: (i) a road surface type; (ii) a road surface condition; (iii) a functional class; (iv) a curvature; (v) a degree of traffic; or (vi) a combination thereof.

5. The apparatus of claim 1, wherein the one or more attributes of the environments of the routes indicates: (i) air temperature levels; (ii) humidity levels; (iii) pavement temperature levels; (iv) precipitation; (v) solar radiation levels; (vi) wind direction and intensity levels; or (vii) a combination thereof.

6. The apparatus of claim 1, wherein the prediction of the one or more tire temperature levels is provided for each tire of the target vehicle.

7. A non-transitory computer-readable storage medium having computer program code instructions stored therein, the computer program code instructions, when executed by at least one processor, cause the at least one processor to:
receive input data indicating a target route for a target vehicle, one or more attributes associated with the target vehicle, and one or more attributes of the target route; and
cause a machine learning model to generate output data as a function of the input data,
wherein the output data indicate prediction of one or more tire temperature levels of the target vehicle during a period in which the target vehicle traverses the target route,
wherein the machine learning model is trained to generate the output data as a function of the input data based on training data, and
wherein the training data indicate events in which vehicles traversed routes, wherein the training data include tire temperature levels of the vehicles during the events, vehicle data indicating one or more attributes of the vehicles, map data indicating one or more attributes of the routes, and environmental data indicating one or more attributes of environments of the routes during the events.

8. The non-transitory computer-readable storage medium of claim 7, wherein the input data does not include tire temperature levels of the target vehicle.

9. The non-transitory computer-readable storage medium of claim 7, wherein the one or more attributes of the vehicles indicates: (i) speed levels of the vehicles; (ii) acceleration or deceleration levels of the vehicles; (iii) total distance travelled by each of the vehicles; (iv) tire pressure levels of the vehicles; (v) specifications of the vehicles; (vi) specifications of wheels of the vehicles; (vii) specifications of tires of the vehicles; (vii) age of each of the vehicles; (xi) age of each tire of the vehicles; (xii) loads of the vehicles; or (xiii) a combination thereof.

10. The non-transitory computer-readable storage medium of claim 7, wherein the one or more attributes of the routes indicates: (i) a road surface type; (ii) a road surface condition; (iii) a functional class; (iv) a curvature; (v) a degree of traffic; or (vi) a combination thereof.

11. The non-transitory computer-readable storage medium of claim 7, wherein the one or more attributes of the environments of the routes indicates: (i) air temperature levels; (ii) humidity levels; (iii) pavement temperature levels; (iv) precipitation; (v) solar radiation levels; (vi) wind direction and intensity levels; or (vii) a combination thereof.

12. The non-transitory computer-readable storage medium of claim 7, wherein the prediction of the one or more tire temperature levels is provided for each tire of the target vehicle.

13. The non-transitory computer-readable storage medium of claim 7, the computer program code instructions, when executed by the at least one processor, further cause the at least one processor to, responsive to the one or more tire temperature levels exceeding a threshold tire temperature level, for each instance in which the one or more tire temperature levels exceeds the threshold tire temperature level:
cause a user interface to output a notification for mitigating increase in temperature levels for one or more tires of the target vehicle, wherein the notification indicates: (i) a recommendation to adjust a departure time of the target route; (ii) a recommendation for a driver of the target vehicle to follow predetermined maneuvers during the period in which the target vehicle traverses the target route; (iii) a recommendation for the target vehicle to slow down or slow to a stop for a predetermined period during the period in which the target vehicle traverses the target route; (iv) an alternative route to a destination of the target route; (v) or a combination thereof.

14. The non-transitory computer-readable storage medium of claim 7, the computer program code instructions, when executed by the at least one processor, further cause the at least one processor to, responsive to the one or more tire temperature levels exceeding a threshold tire temperature level, for each instance in which the one or more tire temperature levels exceeds the threshold tire temperature level:
determine a precipitation location within the target route; and
generate maneuver instructions for traversing the target route based on the precipitation location of the target route.

15. A method of providing predicted tire temperature levels, the method comprising:
receiving input data indicating a target route for a target vehicle, one or more attributes associated with the target vehicle, and one or more attributes of the target route; and
causing a machine learning model to generate output data as a function of the input data,
wherein the output data indicate prediction of one or more tire temperature levels of the target vehicle during a period in which the target vehicle traverses the target route,
wherein the machine learning model is trained to generate the output data as a function of the input data based on training data, and
wherein the training data indicate events in which vehicles traversed routes, wherein the training data include tire temperature levels of the vehicles during the events, vehicle data indicating one or more attributes of the vehicles, map data indicating one or more attributes of the routes, and environmental data indicating one or more attributes of environments of the routes during the events.

16. The method of claim 15, wherein the input data does not include tire temperature levels of the target vehicle.

17. The method of claim 15, wherein the one or more attributes of the vehicles indicates: (i) speed levels of the vehicles; (ii) acceleration or deceleration levels of the vehicles; (iii) total distance travelled by each of the vehicles; (iv) tire pressure levels of the vehicles; (v) specifications of the vehicles; (vi) specifications of wheels of the vehicles; (vii) specifications of tires of the vehicles; (vii) age of each of the vehicles; (xi) age of each tire of the vehicles; (xii) loads of the vehicles; or (xiii) a combination thereof.

18. The method of claim 15, wherein the one or more attributes of the routes indicates: (i) a road surface type; (ii) a road surface condition; (iii) a functional class; (iv) a curvature; (v) a degree of traffic; or (vi) a combination thereof.

19. The method of claim 15, wherein the one or more attributes of the environments of the routes indicates: (i) air temperature levels; (ii) humidity levels; (iii) pavement temperature levels; (iv) precipitation levels; (v) solar radiation levels; (vi) wind direction and intensity levels; or (vii) a combination thereof.

20. The method of claim 15, wherein the prediction of the one or more tire temperature levels is provided for each tire of the target vehicle.
